(19) United States
(12) Patent Application Publication
(10) Pub. No.: US 2009/0026046 A1
(43) Pub. Date: Jan. 29, 2009

(54) Conveying Installation for the Transport of Goods

(75) Inventor: Herbert Trieb, Lochau (AT)

Correspondence Address: LERNER GREENBERG STEMER LLP, P O BOX 2480, HOLLYWOOD, FL, 33022-2480, US

(73) Assignee: INNOVA PATENT GMBH, Wolfurt (AT)

(21) Appl. No.: 11/961,307

(22) Filed: Dec. 20, 2007

(30) Foreign Application Priority Data
Jul. 24, 2007 (AT) A 1171/2007

(51) Int. Cl. B65G 15/00

(52) U.S. Cl. 198/835

(57) ABSTRACT

A conveying installation for the transport of goods has an endless conveyor belt that is guided at the two ends of the installation by deflection drums. The belt is fastened to the underside of carrying beams which are oriented transversely with respect to the direction of movement of the conveyor belt and are located at a distance from one another in the direction of movement of the conveyor belt. Running rollers are mounted in each case on the two lateral ends of the carrying beams. The running rollers roll on two pairs, provided along the installation, of carrying ropes or carrying rails which are assigned to the forward strand and to the return strand of the conveyor belt. At least in the case of some of the carrying beams, a sealing strip consisting of an elastic material is provided between the underside of the carrying beams and the topside of the conveyor belt.

### CROSS-REFERENCE TO RELATED APPLICATION

This application claims the priority, under 35 U.S.C. § 119, of Austrian patent application A1171/2007, filed Jul. 24, 2007; the prior application is herewith incorporated by reference in its entirety.

### BACKGROUND OF THE INVENTION

### Field of the Invention

The present invention relates to a conveying installation for the transport of goods, with a conveyor belt which is guided at the two ends of the installation by deflection drums and which is fastened to the underside of carrying beams which are oriented transversely with respect to the direction of movement of the conveyor belt. The carrying beams are spaced by a spacing distance from one another in the direction of movement of the conveyor belt. Running rollers are mounted in each case on the two lateral ends of the carrying beams. The running rollers roll on two pairs, provided along the installation, of carrying ropes or carrying rails which are assigned to the forward strand and to the return strand of the conveyor belt.

A conveying installation of the type is known, for example, from my earlier, commonly assigned U.S. Pat. No. 6,935,490 B2 and its European counterpart EP 1 452 466 A1. There, the conveyor belt is fastened to the underside of the carrying beams in that there are provided, over the length of the carrying beams, a plurality of screw bolts which are located at a distance from one another and which pass through the carrying beams and the conveyor belt. Since the conveyor belt is designed in its longitudinal direction with pull ropes which reinforce it and are located closely next to one another, it is necessary for no pull ropes to be provided at some locations over the width of the conveyor belt, in order, instead, to provide space for anchoring the screw bolts in the conveyor belt. For this reason, only a small number of screw bolts located at a relatively long distance from one another can be provided over the length of the carrying beams or over the width of the conveyor belt.

However, this type of fastening of the conveyor belt to the carrying beams does not fully satisfy all requirements since the conveyor belt, as a result of its loads, is lifted from the underside of the carrying beams, between the individual screw bolts, by the goods located on the conveyor belt, thus giving rise in each case between the underside of the carrying beams and the topside of the conveyor belt, between the screw bolts, to gaps into which portions of the goods to be conveyed penetrate. As a result of the constant movements of the conveyor belt with respect to the carrying beams, the conveyor belt is consequently subject to greatly increased wear at these locations.

### SUMMARY OF THE INVENTION

It is accordingly an object of the invention to provide a conveying installation for transporting goods which overcomes the above-mentioned disadvantages of the heretofore-known devices and methods of this general type and which, specifically, improves the fastening of the conveyor belt to the underside of the carrying beams.

With the foregoing and other objects in view there is provided, in accordance with the invention, a conveying installation for the transport of goods, comprising:

an endless conveyor belt traveling along a forward strand and a return strand in the conveying installation;

a plurality of carrying beams oriented transversely to, and spaced apart in, a travel direction of said conveyor belt, said conveyor belt being fastened to an underside of said carrying beams;

running rollers mounted in each case to lateral ends of said carrying beams, said running rollers rolling on two pairs of carrying ropes or carrying rails disposed along said forward strand and said return strand of said conveyor belt; and

a sealing strip of an elastic material disposed between at least some of said carrying beams and a topside of said conveyor belt.

In other words, the objects of the invention are achieved, in that, at least in the case of some of the carrying beams, a sealing strip consisting of an elastic material is provided between the underside of the carrying beams and the topside of the conveyor belt.

Preferably, the underside of the sealing strip is connected to the topside of the conveyor belt by adhesive bonding. Further, the topside of the sealing strip may also be connected to the underside of the carrying beams by adhesive bonding.

In accordance with a preferred embodiment of the invention, a plurality of screw bolts are provided over the length of the carrying beams, by means of which the conveyor belt is fastened to the carrying beams. The sealing strip is interposed. Moreover, the sealing strip may be formed from an elastic material with a metallic reinforcing strip. In this case, the conveyor belt may be designed on its underside with a groove which is assigned to the respective carrying beam and is oriented transversely with respect to the direction of movement of the conveyor belt and into which the metallic reinforcing strip is inserted. Alternatively to this, the reinforcing strips are located on that side of the sealing strip which bears against the respective carrying beam. Further, the underside of the carrying beams and the reinforcing strips bearing in each case against these may be designed with tongues and grooves assigned to one another and screw bolts projecting into the reinforcing strips may be located in the carrying beams.

Other features which are considered as characteristic for the invention are set forth in the appended claims.

Although the invention is illustrated and described herein as embodied in conveying installation for the transport of goods, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an axonometric view of a part of a transport installation;

FIG. 2 is an axonometric view of a part of the conveyor belt of the conveying installation according to FIG. 1;

FIG. 3 is a longitudinal section taken through a portion of the conveyor belt according to the invention;

FIG. 4 is a cross section of a first exemplary embodiment of the fastening of the conveyor belt to a carrying beam;

FIG. 5, FIG. 5A, and FIG. 5B are cross-sectional views showing variations of a second exemplary embodiment of the fastening of the conveyor belt to a carrying beam;

FIG. 6 and FIG. 6A are cross-sectional views showing third exemplary embodiments of the fastening of the conveyor belt to a carrying beam; and

FIG. 7 and FIG. 7A are cross-sectional views showing fourth exemplary embodiments of the fastening of the conveyor belt to a carrying beam.

### DETAILED DESCRIPTION OF THE INVENTION

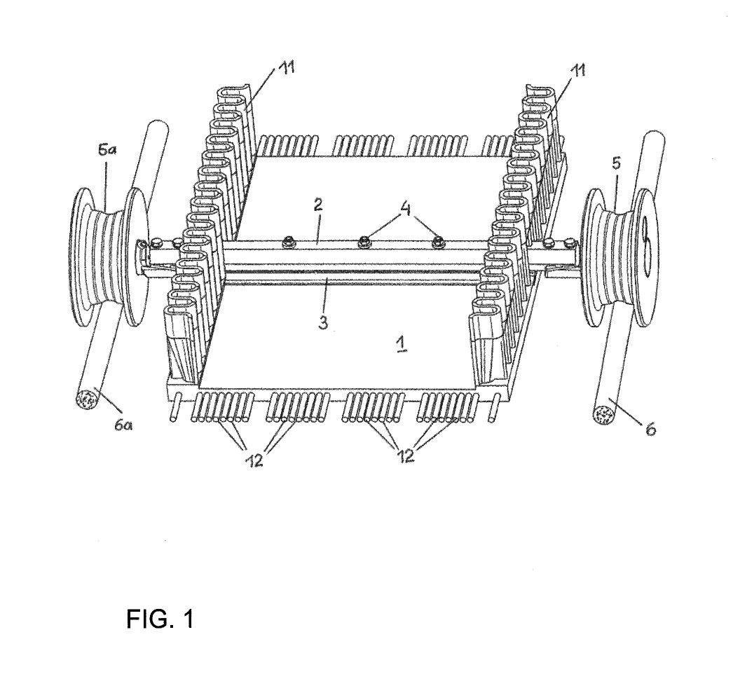

Referring now to the figures of the drawing in detail and first, particularly, to FIG. 1 thereof, there is illustrated a portion of a conveyor belt 1 in a conveying installation for the transport of goods. The conveyor belt 1 is configured at its two lateral margins with corrugated edges 11 which make it possible to guide the conveyor belt at the two ends of the conveying installation by deflection drums. As is evident, further, from this, the conveyor belt 1 is configured with a multiplicity of reinforcing ropes 12 which are located closely next to one another and by virtue of which said conveyor belt has a high carrying capacity. The conveyor belt 1 is fastened to the underside of carrying beams 2 extending transversely with respect to its direction of movement, in each case an elastic sealing strip 3 being located between the conveyor belt 1 and the carrying beams 2. The fastening of the conveyor belt 1 to the carrying beams 2 takes place, for example, by means of screw bolts 4 passing through the conveyor belt 1 and the carrying beams 2. The sealing strips 3 located between the conveyor belt 1 and the carrying beams 2 avoid the situation where, between the conveyor belt 1 and the carrying beams 2, in each case gaps are formed into which goods to be conveyed penetrate, with the result that the conveyor belt 1 is subject to increased wear.

Located at the two ends of the carrying beams 2 are running rollers 5 and 5a which are guided along a pair of carrying ropes 6 and 6a or of carrying rails. In this case, both the strand of the conveyor belt 1 which is laden with goods to be transported and the unladen strand of the conveyor belt 1 are assigned in each case a pair of carrying ropes 6 and 6a or of carrying rails, along which the conveyor belt 1 is moved in rotation between the deflection or drive drums located in the terminal stations.

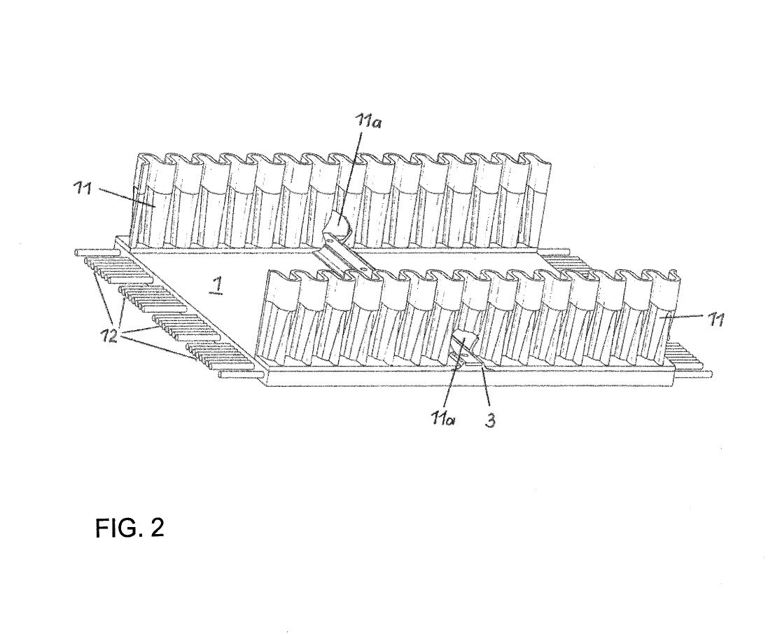

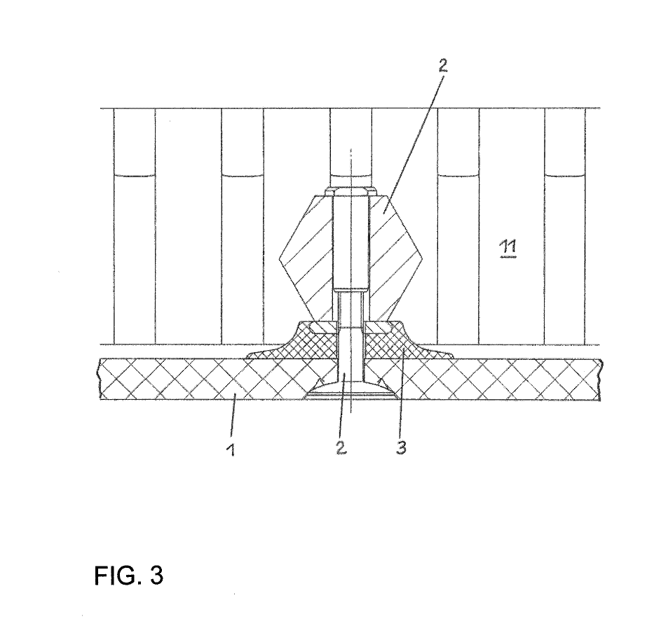

It is evident from FIG. 2 and FIG. 3 that the lateral corrugated edges 11 are designed with recesses 11a for the carrying beams 2, and that the sealing strips 3 are located on the topside of the conveyor belt 1.

The following description deals with the details of how the conveyor belt 1 is fastened to the carrying beams 2:

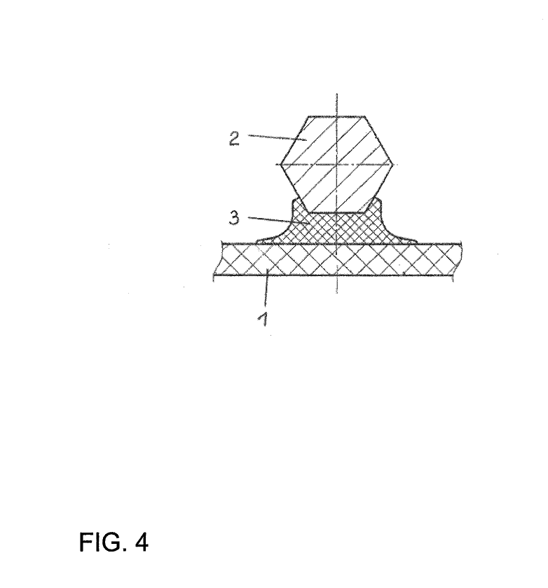

FIG. 4 illustrates a first exemplary embodiment in which the sealing strips 3 located between the carrying beams 2 and the conveyor belt 1 are connected both to the conveyor belt 1 and to the carrying beams 2 by adhesive bonding. The elasticity of the sealing strips 3 ensures that no gaps can be formed between the conveyor belt 1 and the carrying beams 2, with the result that the disadvantages occurring in the prior art, according to which the fastening of the conveyor belt 1 to the carrying beams 2 takes place solely by means of screw bolts located at a distance from one another, are avoided.

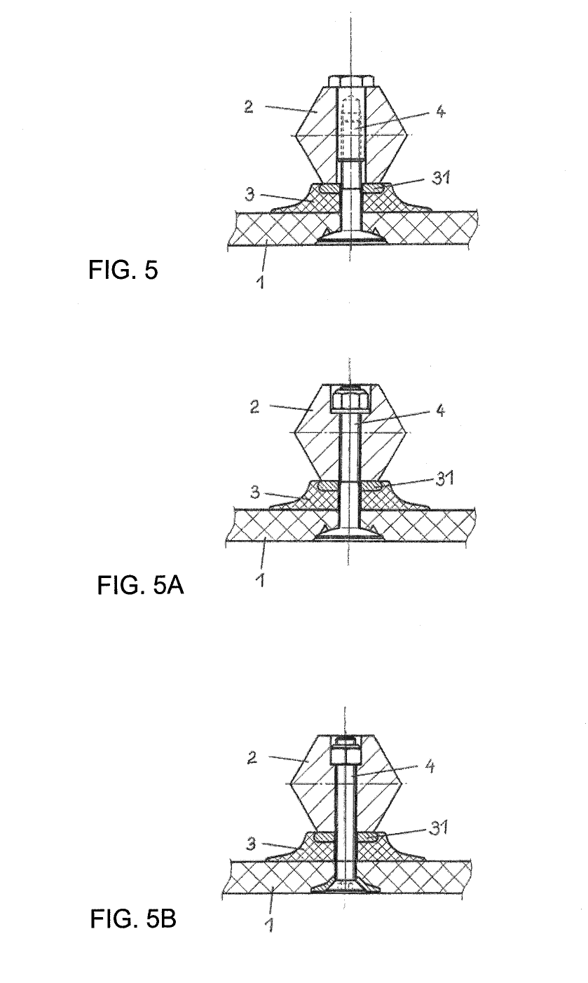

In the exemplary embodiment according to FIG. 5, FIG. 5A and FIG. 5B, the sealing strips 3 are connected to the conveyor belt 1 by adhesive bonding. Further, the sealing strips 3 are in each case designed with reinforcing strips 31 which bear against the carrying beams 2 and which are not bonded adhesively to these. The fastening of the conveyor belt 1 and of the sealing strips 3 to the carrying beams 2 takes place by means of screw bolts 4. In this case, the screw bolts 4 are located at such distances from one another as can be seen from FIG. 1.

The exemplary embodiments according to FIG. 5, FIG. 5A and FIG. 5B differ from one another in the different designs of the screw bolts 4 in which account is taken of the fact that the upper ends of the screw bolts 4 are subject to high wear due to the goods to be conveyed which are transported by the conveyor belt 1, and therefore those structural configurations must be selected which ensure that the screw bolts 4 can be released again at any time as soon as this is necessary for the exchange of carrying beams 2.

The formation of gaps between the conveyor belt 1 and the carrying beams 2 is also avoided in this type of fastening of the conveyor belt 1 to the carrying beams 2, with the sealing strip 3 inserted. On account of the screw connections, the carrying beams 2 can be released from the conveyor belt 1 in a simple way.

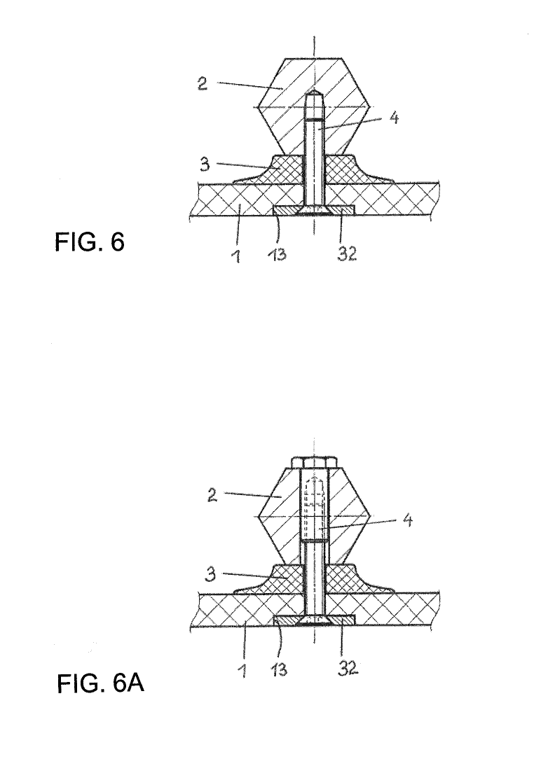

The third exemplary embodiment of the fastening of the conveyor belt 1 to the carrying beams 2 according to FIG. 6 and FIG. 6A differs from the exemplary embodiment according to FIG. 5, FIG. 5A and FIG. 5B in that, on the underside of the conveyor belt 1, grooves 13 are provided, in which are located reinforcing strips 32, by which the conveyor belt 1 is pressed against the carrying beams 2 over the entire width of the conveyor belt 1, and the sealing strips 3 interposed, by means of the screw bolts 4 which pass through the sealing strips 3, the conveyor belt 1 and the reinforcing strips 32, with the result that the formation of gaps between the conveyor belt 1 and the carrying beams 2 is likewise ruled out. In this case, too, the sealing strips 3 are adhesively bonded to the conveyor belt 1. Moreover, in this case, the screw bolts 4 are designed such that they can be released at any time.

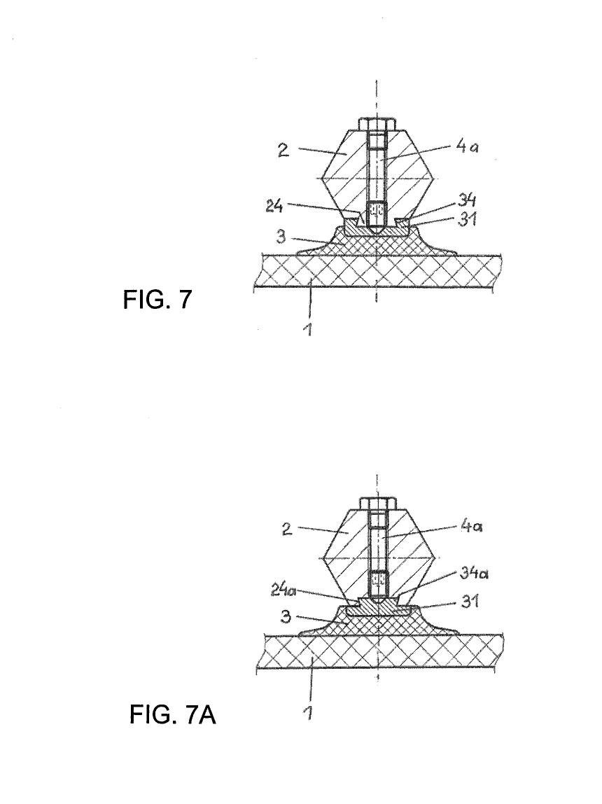

In the fourth exemplary embodiment according to FIG. 7 and FIG. 7A, the conveyor belt 1 is likewise connected to the sealing strips 3 by means of adhesive bonding. Further, on that side of the sealing strips 3 which faces the carrying beams 2, upper reinforcing strips 31 are located which are connected to the sealing strips 3 by adhesive bonding. According to FIG. 7, the upper reinforcing strips 31 are designed in each case with an undercut groove 34 into which undercut tongues 24 projecting from the carrying beams 2 penetrate, with the result that the sealing strips 3 and consequently the conveyor belt 1 are fastened to the carrying beams 2.

In the exemplary embodiment according to FIG. 7A, the reinforcing strips 31 are designed with an undercut tongue 34a and the carrying beams 2 are designed with undercut grooves 24a.

By virtue of these two designs, the conveyor belt 1 can be connected releasably to the carrying beams 2 in a simple way. In order to achieve the required positional stability, screws 4a pass through the carrying beams 2 and project into bores provided in the reinforcing strips 31.

In a preferred implementation, the carrying beams 2 are hexagonal in cross section, and they are formed as solid bodies, that is to say not tubular. As a result, they make it possible to have long operating times even in the event of high wear caused by the goods to be transported.

1. A conveying installation for the transport of goods, comprising:
an endless conveyor belt traveling along a forward strand and a return strand in the conveying installation;
a plurality of carrying beams oriented transversely to, and spaced apart in, a travel direction of said conveyor belt, said conveyor belt being fastened to an underside of said carrying beams;
running rollers mounted in each case to lateral ends of said carrying beams, said running rollers rolling on two pairs of carrying ropes or carrying rails disposed along said forward strand and said return strand of said conveyor belt; and
a sealing strip of an elastic material disposed between at least some of said carrying beams and a topside of said conveyor belt.

2. The conveying installation according to claim 1, wherein said sealing strip has an underside connected to the topside of the conveyor belt by adhesive bonding.

3. The conveying installation according to claim 1, wherein said sealing strip has a topside connected to said underside of said carrying beams by adhesive bonding.

4. The conveying installation according to claim 1, which comprises a plurality of screw bolts distributed over a length of said carrying beams, said screw bolts fastening said conveyor belt to said carrying beams, with said sealing strip disposed in between.

5. The conveying installation according to claim 1, wherein said sealing strip is formed of an elastic material with a metallic reinforcing strip.

6. The conveying installation according to claim 5, wherein said conveyor belt has an underside formed with a groove assigned to a respective said carrying beam and oriented transversely with respect to the travel direction of said conveyor belt, and wherein said metallic reinforcing strip is inserted into said groove.

7. The conveying installation according to claim 5, wherein said reinforcing strip is disposed on a side of said sealing strip bearing against the respective said carrying beam.

8. The conveying installation according to claim 7, wherein said underside of said carrying beams and said reinforcing strips bearing in each case against said carrying beams are formed with tongues and grooves assigned to one another, and wherein screw bolts projecting into said reinforcing strips are disposed in said carrying beams.
